(19) United States
(12) Patent Application Publication
(10) Pub. No.: US 2007/0142565 A1
(43) Pub. Date: Jun. 21, 2007

(54) Rheology modification of polymers

(75) Inventors: Bharat I. Chaudhary, Princeton, NJ (US); Randall M. Cuntala, Columbia, NJ (US); Mohamed Esseghir, Monroe Township, NJ (US); John Klier, Midland, MI (US); Yunwa W. Cheung, Lake Jackson, TX (US)

Correspondence Address: THE DOW CHEMICAL COMPANY, INTELLECTUAL PROPERTY SECTION,, P. O. BOX 1967, MIDLAND, MI, 48641-1967, US

(73) Assignee: DOW GLOBAL TECHNOLOGIES INC., MIDLAND MI, MI (US)

(21) Appl. No.: 10/583,296

(22) PCT Filed: Dec. 24, 2004
(86) PCT No.: PCT/US04/43355

§ 371 Date: Jun. 16, 2006

Related U.S. Application Data
(60) Provisional application No. 60/532,491, filed on Dec. 24, 2003.

(51) Int. Cl. C08F 120/10

(52) U.S. Cl. 525/330.3; 525/356; 525/333.7

(57) ABSTRACT

The present invention is a rheology-modifiable polymeric composition. The resulting rheology-modified polymer is prepared from at least one polymer which upon forming free radicals preferentially degrades or carbon-carbon crosslinks. The present invention permits suppression of the preferential reaction while permitting the polymer to be coupled through a free-radical trapping species. Suppressing the undesirable degradation or carbon-carbon crosslinking reaction and permitting the desirable coupling reaction yield a rheology-modified polymer.

### FIELD OF THE INVENTION

This invention relates to polymer systems that undergo free radical reactions, wherein modifying the rheology of a polymer is desirable.

### DESCRIPTION OF THE PRIOR ART

A number of polymers can undergo free radical reactions. Some of those reactions are beneficial such as coupling (or rheology-modifying) while others are detrimental such as degrading or carbon-carbon crosslinking. There is a need to promote the beneficial coupling reaction while minimizing the impact of the detrimental reactions.

Polyolefins are frequently rheology-modified using nonselective free-radical chemistries. However, free-radical chemistries at elevated temperatures can also degrade the molecular weight, especially in polymers containing tertiary hydrogen such as polypropylene and polystyrene. Also, free-radical chemistries can promote carbon-carbon crosslinking, resulting in undesirable gel levels for polyethylene.

To mitigate the free-radical degradation of polypropylene, the use of peroxides and pentaerythritol triacrylate is reported by Wang et al., in Journal of Applied Polymer Science, Vol. 61, 1395-1404 (1996). They teach that branching of isotactic polypropylene can be realized by free radical grafting of di- and tri-vinyl compounds onto polypropylene. However, this approach does not work well in actual practice as the higher rate of chain scission tends to dominate the limited amount of chain coupling that takes place.

Chain scission results in lower molecular weight and higher melt flow rate than would be observed were the chain coupling not accompanied by scission. Because scission is not uniform, molecular weight distribution increases as lower molecular weight polymer chains referred to in the art as “tails” are formed.

Another approach to producing rheology-modified polymers is described in U.S. Pat. Nos. 3,058,944; 3,336,268; and 3,530,108—the reaction of certain poly(sulfonyl azide) compounds with isotactic polypropylene or other polyolefins by nitrene insertion into C—H bonds. The product reported in U.S. Pat. No. 3,058,944 is crosslinked. The product reported in U.S. Pat. No. 3,530,108 is foamed and cured with a cycloalkane-di(sulfonyl azide). In U.S. Pat. No. 3,336,268, the resulting reaction products are referred to as “bridged polymers” because polymer chains are “bridged” with sulfonamide bridges.

It is desirable to increase the melt viscosity and melt strength of various polymers by coupling the polymer, without chain scission or carbon-carbon crosslinking the polymer. If the polymer is halogenated, it is also desirable that the polymer not undergo dehydrohalogenation.

It is desirable to yield a rheology-modified polymer with low level of gels and excellent clarity. It is also desirable to control the molecular architecture of the polymer as it undergoes the coupling reaction.

### SUMMARY OF THE INVENTION

The present invention is a rheology-modifiable polymeric composition. The resulting rheology-modified polymer is prepared from at least one polymer which upon forming free radicals preferentially degrades or carbon-carbon crosslinks. The present invention permits suppression of the preferential reaction while permitting the polymer to be coupled through a free-radical trapping species. Suppressing the undesirable degradation or carbon-carbon crosslinking reaction and permitting the desirable coupling reaction yield a rheology-modified polymer.

The present invention is useful in wire-and-cable, footwear, film (e.g. greenhouse, shrink, and elastic), engineering thermoplastic, highly-filled, flame retardant, reactive compounding, thermoplastic elastomer, thermoplastic vulcanizate, automotive, vulcanized rubber replacement, construction, automotive, furniture, foam, wetting, adhesive, paintable substrate, dyeable polyolefin, moisture-cure, nanocomposite, compatibilizing, wax, calendared sheet, medical, dispersion, coextrusion, cement/plastic reinforcement, food packaging, non-woven, paper-modification, multilayer container, sporting good, oriented structure, and surface treatment applications.

### DESCRIPTION OF THE INVENTION

“Carbon-FRTS-Carbon Coupling Bond,” as used herein, means covalent bonds formed between a carbon of a polymer molecule, a free-radical trapping species, and a carbon of another polymer molecule. Prior to formation of the carbon-FRTS-carbon coupling bond, the free-radical trapping species has at least two trapping sites. At two of the trapping sites, the free-radical trapping species is grafted to the polymer molecules.

“Constrained geometry catalyst catalyzed polymer”, “CGC-catalyzed polymer” or similar term, as used herein, means any polymer that is made in the presence of a constrained geometry catalyst. “Constrained geometry catalyst” or “CGC,” as used herein, has the same meaning as this term is defined and described in U.S. Pat. Nos. 5,272,236 and 5,278,272.

“Gel Number,” as used herein, means the average number of gels per square meter of evaluated polymeric composition as measured by extruding the polymer through a film die and using a Film Scanning System (FS-3) from Optical Counter System (OCS). “GN-300,” as used herein, means the average number of gels per square meter having a particle size of at least 300 micrometers. GN-300 would represent the total number of gels for 300-1600 micrometer measurements. “GN-600,” as used herein, means the average number of gels per square meter having a particle size of at least 600 micrometers. GN-600 would represent the total number of gels for 600-1600 micrometer measurements.

“Homogeneously Coupled,” as used herein, refers to the range of molecular weight over which branching is present as shown by a Mark-Houwink plot resulting from gel permeation chromatography (“GPC”) analysis. A broader range indicates more homogeneous coupling.

“Long Chain Branching (LCB),” as used herein, means, for example, with ethylene/alpha-olefin copolymers, a chain length longer than the short chain branch that results from the incorporation of the alpha-olefin(s) into the polymer backbone. Each long chain branch has the same comonomer distribution as the polymer backbone and can be as long as the polymer backbone to which it is attached.

“Melt Processable,” as used herein, means the polymer after being rheologically-modified continues exhibiting a thermoplastic behavior as characterized by the polymer being able to undergo melting and to flow in a viscous manner such that the polymer could be processed in conventional processing equipment such as extruders and shaping dies.

“Melt Strength,” as used herein, means the maximum tensile force at break or at the onset of draw resonance. Melt strength is measured according to the Rheotens melt strength method. It consists of extruding a molten strand of polymer at a constant output rate using either a capillary rheometer or an extruder and drawing the strand down between a set of wheels. The wheels are rotated at a constant acceleration, producing a drawing velocity which increases linearly with time. The strand thins due to the increasing drawdown ratio until it breaks. During this process, the tension force of the strand acting on the wheels is recorded and the following information is provided: (a) “drawing strength,” as used herein, means the force, or stress, required to draw the material at a given speed; (b) “drawability,” as used herein means the maximum velocity, or strain, rate at which a material can be drawn without web or fiber breaks; and (c) “drawdown stability,” as used herein, means the critical velocity at which web or bubble oscillation is likely to occur.” The measurement conditions are as follows: A Rheotester 2000 capillary rheometer is used, which is commercially available from Gottfert Inc. The die dimensions are L/D=30/2 mm and 180° angle. The barrel diameter is 12 mm. The test temperature is 200 degrees Celsius. The piston speed (shear rate) is 0.265 mm/s (38.2 l/s). The draw distance is 100 mm. The rheotens wheel acceleration is 24 mm/s².

“Metallocene,” as used herein, means a metal-containing compound having at least one substituted or unsubstituted cyclopentadienyl group bound to the metal. “Metallocene-catalyzed polymer” or similar term means any polymer that is made in the presence of a metallocene catalyst.

“Polydisperity”, “molecular weight distribution”, and similar terms, as used herein, means a ratio (M_{w}/Mₙ) of weight average molecular weight (M_{w}) to number average molecular weight (Mₙ).

“Polymer,” as used herein, means a macromolecular compound prepared by polymerizing monomers of the same or different type. “Polymer” includes homopolymers, copolymers, terpolymers, interpolymers, and so on. The term “interpolymer” means a polymer prepared by the polymerization of at least two types of monomers or comonomers. It includes, but is not limited to, copolymers (which usually refers to polymers prepared from two different types of monomers or comonomers, although it is often used interchangeably with “interpolymer” to refer to polymers made from three or more different types of monomers or comonomers), terpolymers (which usually refers to polymers prepared from three different types of monomers or comonomers), tetrapolymers (which usually refers to polymers prepared from four different types of monomers or comonomers), and the like. The terms “monomer” or “comonomer” are used interchangeably, and they refer to any compound with a polymerizable moiety which is added to a reactor in order to produce a polymer. In those instances in which a polymer is described as comprising one or more monomers, e.g., a polymer comprising propylene and ethylene, the polymer, of course, comprises units derived from the monomers, e.g., —CH₂—CH₂—, and not the monomer itself, e.g., CH₂═CH₂.

“P/E* copolymer” and similar terms, as used herein, means a propylene/unsaturated comonomer copolymer characterized as having at least one of the following properties: (i) ¹³C NMR peaks corresponding to a regio-error at about 14.6 and about 15.7 ppm, the peaks of about equal intensity and (ii) a differential scanning calorimetry (DSC) curve with a Tₘₑ that remains essentially the same and a Tₚₑₐₖ that decreases as the amount of comonomer, i.e., the units derived from ethylene and/or the unsaturated comonomer(s), in the copolymer is increased. “Tₘₑ” means the temperature at which the melting ends. “Tₚₑₐₖ” means the peak melting temperature. Typically, the copolymers of this embodiment are characterized by both of these properties. Each of these properties and their respective measurements are described in detail in U.S. patent application Ser. No. 10/139,786, filed May 5, 2002 (WO2003040442) which is incorporated herein by reference.

These copolymers can be further characterized further as also having a skewness index, Sᵢₓ, greater than about −1.20. The skewness index is calculated from data obtained from temperature-rising elution fractionation (TREF). The data is expressed as a normalized plot of weight fraction as a function of elution temperature. The molar content of isotactic propylene units that primarily determines the elution temperature.

A prominent characteristic of the shape of the curve is the tailing at lower elution temperature compared to the sharpness or steepness of the curve at the higher elution temperatures. A statistic that reflects this type of asymmetry is skewness. Equation 1 mathematically represents the skewness index, Sᵢₓ, as a measure of this asymmetry.

$${S}_{ix} = \frac{\sqrt[3]{\sum {w}_{i} * {( {T}_{i} - {T}_{Max} )}^{3}}}{\sqrt{\sum {w}_{i} * {( {T}_{i} - {T}_{Max} )}^{2}}} . \qquad Equation 1$$

The value, Tₘₐₓ, is defined as the temperature of the largest weight fraction eluting between 50 and 90 degrees C. in the TREF curve. Tᵢ and wᵢ are the elution temperature and weight fraction respectively of an arbitrary, i^{th} fraction in the TREF distribution. The distributions have been normalized (the sum of the wᵢ equals 100%) with respect to the total area of the curve eluting above 30 degrees C. Thus, the index reflects only the shape of the crystallized polymer. Any uncrystallized polymer (polymer still in solution at or below 30 degrees C.) is omitted from the calculation shown in Equation 1.

The unsaturated comonomers for P/E* copolymers include C₄₋₂₀ α-olefins, especially C₄₋₁₂ α-olefins such as 1-butene, 1-pentene, 1-hexene, 4-methyl-1-pentene, 1-heptene, 1-octene, 1-decene, 1-dodecene and the like; C₄₋₂₀ diolefins, preferably 1,3-butadiene, 1,3-pentadiene, norbornadiene, 5-ethylidene-2-norbornene (ENB) and dicyclopentadiene; C₈₋₄₀ vinyl aromatic compounds including sytrene, o-, m-, and p-methylstyrene, divinylbenzene, vinylbiphenyl, vinylnapthalene; and halogen-substituted C₈₋₄₀ vinyl aromatic compounds such as chlorostyrene and fluorostyrene. Ethylene and the C₄₋₁₂ α-olefins are the preferred comonomers, and ethylene is an especially preferred comonomer.

P/E* copolymers are a unique subset of P/E copolymers. P/E copolymers include all copolymers of propylene and an unsaturated comonomer, not just P/E* copolymers. P/E copolymers other than P/E* copolymers include metallocene-catalyzed copolymers, constrained geometry catalyst catalyzed copolymers, and Z-N-catalyzed copolymers. For purposes of this invention, P/E copolymers comprise 50 weight percent or more propylene while EP (ethylene-propylene) copolymers comprise 51 weight percent or more ethylene. As here used, “comprise . . . propylene”, “comprise . . . ethylene” and similar terms mean that the polymer comprises units derived from propylene, ethylene or the like as opposed to the compounds themselves.

“Propylene homopolymer” and similar terms mean a polymer consisting solely or essentially all of units derived from propylene. “Polypropylene copolymer” and similar terms mean a polymer comprising units derived from propylene and ethylene and/or one or more unsaturated comonomers.

“Rheology Modified,” as used herein, means change in melt viscosity of a polymer as determined by dynamic mechanical spectroscopy (DMS). The change of melt viscosity is evaluated for high shear viscosity measured at a shear of 100 rad/sec and for low shear viscosity measured at a shear of 0.1 rad/sec.

The rheology of a polymer is desirably modified according to the present invention such that the melt strength increases while maintaining about the same high shear viscosity. That is, the rheology-modified polymer exhibits more resistance to stretching during elongation of molten polymer at low shear conditions but does not sacrifice the output at high shear conditions when compared with its base polymer. In the present invention, it is desirable that the viscosity at the low shear conditions increases by at least about 5 percent above the base polymer. An increase in melt strength is typically observed when long chain branches or similar structures are introduced into a polymer.

Alternatively, the rheology of a polymer modified according to the present invention may be described with reference to the ratio of the low shear viscosity versus the high shear viscosity (“low/high shear viscosity ratio”). In particular, a rheology-modified polymer of the present invention may be characterized as having a low/high shear viscosity ratio greater than the low/high shear viscosity ratio of its base polymer. Preferably, the low/high shear viscosity ratio is increased by at least 5 percent, more preferably by at least 10%, and even more preferably by at least 20%. Also, preferably, the low/high shear viscosity ratio is increased while maintaining or decreasing the high shear viscosity. More preferably, the low/high shear viscosity ratio is increased while maintaining a comparable high shear viscosity. An increase in the low/high shear viscosity ratio is typically observed when long chain branches or similar structures are introduced into a polymer.

Without regard to whether a rheology-modified polymer is characterized by its melt strength or its low/high shear viscosity ratio, the rheology-modified polymer preferably achieves a GN-300 less than or equal to its base polymer. Also preferably, the rheology-modified polymer preferably achieves a GN-600 less than or equal to its base polymer. Also preferably, the rheology-modified polymer's GN is less than about 50 percent of its base polymer.

Alternatively and also preferably, without regard to whether a rheology-modified polymer is characterized by its melt strength or its low/high shear viscosity ratio, the rheology-modified polymer achieves a GN-300 less than 100 gels. More preferably, the rheology-modified polymer achieves a GN-300 less than 50 gels.

Alternatively and also preferably, without regard to whether a rheology-modified polymer is characterized by its melt strength or its low/high shear viscosity ratio, the resulting rheology-modified polymer will have a gel content as measured by xylene extraction (ASTM 2765) of less than about 10 weight percent, more preferably less than about 5 weight percent. Also preferably, the gel content of the rheology-modified polymer will be less than an absolute 5 weight percent greater than the gel content of the base polymer (the unmodified polymer).

Alternatively and also preferably, the resulting rheology-modified polymer will have its Maximum Torque less than about 1.30 times its Minimum Torque, both measured at the crosslinking temperature of the polymer.
M_{H}<1.30×M_{L}

“Ziegler-Natta-catalyzed polymer,” “Z-N-catalyzed polymer,” or similar term means any polymer that is made in the presence of a Ziegler-Natta catalyst.

In one embodiment, the present invention is a rheology-modifiable polymeric composition, which comprises a free-radical degradable polymer, a free-radical inducing species, and a free radical trapping species having at least two trapping sites. The polymer is capable of forming free radicals when induced by the free-radical inducing species.

In the absence of the free-radical trapping species and when induced by the free-radical inducing species, the polymer undergoes a degradation reaction in the presence of the free-radical inducing species. The degradation reaction can be chain scission or dehydrohalogenation. The free radical trapping species substantially suppresses the degradation reaction.

At the trapping sites, the free-radical trapping species is graftable onto the polymer after the polymer forms a free radical. A melt-processable, rheology-modified polymer is yielded. Preferably, the rheology-modified polymer is branched. Also, preferably, the rheology-modified polymer will be substantially homogeneously coupled.

A variety of free-radical degradable polymers is useful in the present invention as the polymer. The free-radical degradable polymer can be hydrocarbon-based. Suitable free-radical degradable, hydrocarbon-based polymers include butyl rubber, polyacrylate rubber, polyisobutene, propylene homopolymers, propylene copolymers, styrene/butadiene/styrene block copolymers, styrene/ethylene/butadiene/styrene copolymers, polymers of vinyl aromatic monomers, vinyl chloride polymers, and blends thereof.

Preferably, the free-radical degradable, hydrocarbon-based polymer is selected from the group consisting of isobutene, propylene, and styrene polymers.

Preferably, the butyl rubber of the present invention is a copolymer of isobutylene and isoprene. The isoprene is typically used in an amount between about 1.0 weight percent and about 3.0 weight percent.

Examples of propylene polymers useful in the present invention include propylene homopolymers and P/E copolymers. In particular, these propylene polymers include polypropylene elastomers. The propylene polymers can be made by any process and can be made by Zeigler-Natta, CGC, metallocene, and nonmetallocene, metal-centered, heteroaryl ligand catalysis.

Useful propylene copolymers include random, block and graft copolymers. Exemplary propylene copolymers include Exxon-Mobil VISTAMAX, Mitsui TAFMER, and VERSIFY™ by The Dow Chemical Company. The density of these copolymers is typically at least about 0.850, preferably at least about 0.860 and more preferably at least about 0.865, grams per cubic centimeter (g/cm³).

Typically, the maximum density of these propylene copolymers is about 0.915, preferably the maximum is about 0.900 and more preferably the maximum is about 0.890 g/cm³. The weight average molecular weight (Mw) of these propylene copolymers can vary widely, but typically it is between about 10,000 and 1,000,000. The polydispersity of these copolymers is typically between about 2 and about 4.

These propylene copolymers typically have a melt flow rate (MFR) of at least about 0.01, preferably at least about 0.05, and more preferably at least about 0.1. The maximum MFR typically does not exceed about 2,000, preferably it does not exceed about 1000, more preferably it does not exceed about 500, further more preferably it does not exceed about 80 and most preferably it does not exceed about 50. MFR for copolymers of propylene and ethylene and/or one or more C₄-C₂₀ α-olefins is measured according to ASTM D-1238, condition L (2.16 kg, 230 degrees C.).

Styrene/butadiene/styrene block copolymers useful in the present invention are a phase-separated system. Styrene/ethylene/butadiene/styrene copolymers are also useful in the present invention.

Polymers of vinyl aromatic monomers are useful in the present invention. Suitable vinyl aromatic monomers include, but are not limited to, those vinyl aromatic monomers known for use in polymerization processes, such as those described in U.S. Pat. Nos. 4,666,987; 4,572,819 and 4,585,825.

Preferably, the monomer is of the formula: 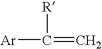
wherein R′ is hydrogen or an alkyl radical containing three carbons or less, Ar is an aromatic ring structure having from 1 to 3 aromatic rings with or without alkyl, halo, or haloalkyl substitution, wherein any alkyl group contains 1 to 6 carbon atoms and haloalkyl refers to a halo substituted alkyl group. Preferably, Ar is phenyl or alkylphenyl, wherein alkylphenyl refers to an alkyl substituted phenyl group, with phenyl being most preferred. Typical vinyl aromatic monomers which can be used include: styrene, alpha-methylstyrene, all isomers of vinyl toluene, especially para-vinyltoluene, all isomers of ethyl styrene, propyl styrene, vinyl biphenyl, vinyl naphthalene, vinyl anthracene and the like, and mixtures thereof.

The vinyl aromatic monomers may also be combined with other copolymerizable monomers. Examples of such monomers include, but are not limited to acrylic monomers such as acrylonitrile, methacrylonitrile, methacrylic acid, methyl methacrylate, acrylic acid, and methyl acrylate; maleimide, phenylmaleimide, and maleic anhydride. In addition, the polymerization may be conducted in the presence of predissolved elastomer to prepare impact modified, or grafted rubber containing products, examples of which are described in U.S. Pat. Nos. 3,123,655, 3,346,520, 3,639,522, and 4,409,369.

The present invention is also applicable to the rigid, matrix or continuous phase polymer of rubber-modified monovinylidene aromatic polymer compositions.

Useful free-radical inducing species include organic peroxides, Azo free radical initiators, and bicumene. Preferably, the free-radical inducing species is an organic peroxide. Also, oxygen-rich environments are preferred for initiating useful free-radicals. Preferable organic peroxides include dicumyl peroxide, Vulcup R, and dialkyl peroxides. More preferable, the organic peroxide is a dialkyl peroxide selected from the group consisting of 2,5-bis(tert-butylperoxy)-2,5-dimethylhexane and 2,5-bis(tert-butylperoxy)-2,5-dimethyl-3-hexyne. Most preferably, the organic peroxide is 2,5-bis(tert-butylperoxy)-2,5-dimethyl-3-hexyne.

The organic peroxide can be added via direct injection. Preferably, the free-radical inducing species is present in an amount between about 0.005 weight percent and about 20.0 weight percent, more preferably, between about 0.01 weight percent and about 10.0 weight percent, most preferably, between about 0.03 weight percent and about 5.0 weight percent.

In addition to or as alternative to the free-radical inducing species, the polymer can form free radicals when subjected to shear energy, heat, or radiation. Accordingly, shear energy, heat, or radiation can act as free-radical inducing species. Moreover, the free-radical trapping species can act in the presence of free-radicals generated by shear energy, heat, or radiation as the free-radical trapping species would act in the presence of free radicals generated by the previously-described free-radical inducing species.

It is believed that when the free-radicals are generated by an organic peroxide, oxygen, air, shear energy, heat, or radiation, the combination of the free-radical trapping species and the source of free-radical is required for coupling of the polymer. Control of this combination determines the molecular architecture of the coupled polymer (that is, the rheology-modified polymer). Sequential addition of the free-radical trapping species followed by gradual initiation of free radicals provides an unprecedented degree of control over the molecular architecture.

It is also believed that grafting sites can be initiated on the polymer and capped with the free-radical trapping species to form a pendant stable free radical. Later, the pendant stable free radical can couple with a subsequently formed free radical, imparting desired levels of homogeneity to the resulting rheology-modified polymer.

Examples of the free radical trapping species useful in the present invention include hindered amine-derived stable organic free radicals. Preferably, when the free radical trapping species is a hindered amine-derived stable organic free radical, it is selected from the group consisting of multi-functional molecules having at least two functional groups of 2,2,6,6,-tetramethyl piperidinyl oxy (TEMPO) and derivatives thereof. More preferably, the stable organic free radical is a bis-TEMPO. An example of a bis-TEMPO is bis(1-oxyl-2,2,6,6-tetramethylpiperidine-4-yl)sebacate. Also, even more preferably, the stable organic free radical is a multi-functional molecule having at least two nitroxyl groups derived from oxo-TEMPO, hydroxy-TEMPO, an ester of hydroxy-TEMPO, polymer-bound TEMPO, PROXYL, DOXYL, di-tertiary butyl N oxyl, dimethyl diphenylpyrrolidine-1-oxyl, 4 phosphonoxy TEMPO, or a metal complex with TEMPO.

Preferably, the free radical trapping species is present in an amount between about 0.005 weight percent and about 20.0 weight percent, more preferably, between about 0.01 weight percent and about 10.0 weight percent, most preferably, between about 0.03 weight percent and about 5.0 weight percent.

Preferably, the ratio of the free-radical inducing species to the free radical trapping species and the concentration of the free-radical trapping species promote coupling of the polymer. More preferably, the free-radical inducing species to the free-radical trapping species are present in a ratio greater than about 1, more preferably, between about 20:1 to about 1:1.

The free-radical trapping species and the free-radical inducing species can be combined with the polymer in a variety of ways, including direct compounding, direct soaking, and direct injection.

In an alternate embodiment, the present invention is a rheology-modifiable polymeric composition, which comprises a free-radical carbon-carbon crosslinkable polymer, a free-radical inducing species, and a free radical trapping species having at least two trapping sites. The polymer is capable of forming free radicals when induced by the free-radical inducing species.

In the absence of the free-radical trapping species and when induced by the free-radical inducing species, the polymer undergoes a carbon-carbon crosslinking reaction. The free radical trapping species substantially suppresses the carbon-carbon crosslinking reaction.

At the trapping sites, the free-radical trapping species is graftable onto the polymer after the polymer forms a free radical. A melt-processable, rheology-modified polymer is yielded. Preferably, the rheology-modified polymer is branched. Also, preferably, the rheology-modified polymer will be substantially homogeneously coupled.

A variety of free-radical carbon-carbon crosslinkable polymers is useful in the present invention as the polymer. The polymer can be hydrocarbon-based. Suitable free-radical carbon-carbon crosslinkable, hydrocarbon-based polymers include acrylonitrile butadiene styrene rubber, chloroprene rubber, chlorosulfonated polyethylene rubber, ethylene/alpha-olefin copolymers, ethylene/diene copolymer, ethylene homopolymers, ethylene/propylene/diene monomers, ethylene/propylene rubbers, ethylene/styrene interpolymers, ethylene/unsaturated ester copolymers, fluoropolymers, halogenated polyethylenes, hydrogenated nitrile butadiene rubber, natural rubber, nitrile rubber, polybutadiene rubber, silicone rubber, styrene/butadiene rubber, styrene/butadiene/styrene block copolymers, styrene/ethylene/butadiene/styrene copolymers, and blends thereof.

For the present invention, chloroprene rubbers are generally polymers of 2-chloro-1,3-butadiene. Preferably, the rubber is produced by an emulsion polymerization. Additionally, the polymerization can occur in the presence of sulfur to incorporate crosslinking in the polymer.

Preferably, the free-radical carbon-carbon crosslinkable, hydrocarbon-based polymer is an ethylene polymer.

With regard to the suitable ethylene polymers, the polymers generally fall into four main classifications: (1) highly-branched; (2) heterogeneous linear; (3) homogeneously branched linear; and (4) homogeneously branched substantially linear. These polymers can be prepared with Ziegler-Natta catalysts, metallocene or vanadium-based single-site catalysts, or constrained geometry single-site catalysts.

Highly branched ethylene polymers include low density polyethylene (LDPE). Those polymers can be prepared with a free-radical initiator at high temperatures and high pressure. Alternatively, they can be prepared with a coordination catalyst at high temperatures and relatively low pressures. These polymers have a density between about 0.910 grams per cubic centimeter and about 0.940 grams per cubic centimeter as measured by ASTM D-792.

Heterogeneous linear ethylene polymers include linear low density polyethylene (LLDPE), ultra-low density polyethylene (ULDPE), very low density polyethylene (VLDPE), and high density polyethylene (HDPE). Linear low density ethylene polymers have a density between about 0.850 grams per cubic centimeter and about 0.940 grams per cubic centimeter and a melt index between about 0.01 to about 100 grams per 10 minutes as measured by ASTM 1238, condition I. Preferably, the melt index is between about 0.1 to about 50 grams per 10 minutes. Also, preferably, the LLDPE is an interpolymer of ethylene and one or more other alpha-olefins having from 3 to 18 carbon atoms, more preferably from 3 to 8 carbon atoms. Preferred comonomers include 1-butene, 4-methyl-1-pentene, 1-hexene, and 1-octene.

Ultra-low density polyethylene and very low density polyethylene are known interchangeably. These polymers have a density between about 0.870 grams per cubic centimeter and about 0.910 grams per cubic centimeter. High density ethylene polymers are generally homopolymers with a density between about 0.941 grams per cubic centimeter and about 0.965 grams per cubic centimeter.

Homogeneously branched linear ethylene polymers include homogeneous LLDPE. The uniformly branched/homogeneous polymers are those polymers in which the comonomer is randomly distributed within a given interpolymer molecule and wherein the interpolymer molecules have a Similar ethylene/comonomer ratio within that interpolymer.

Homogeneously-branched substantially linear ethylene polymers include (a) homopolymers of C₂-C₂₀ olefins, such as ethylene, propylene, and 4-methyl-1-pentene, (b) interpolymers of ethylene with at least one C₃-C₂₀ alpha-olefin, C₂-C₂₀ acetylenically unsaturated monomer, C₄-C₁₈ diolefin, or combinations of the monomers, and (c) interpolymers of ethylene with at least one of the C₃-C₂₀ alpha-olefins, diolefins, or acetylenically unsaturated monomers in combination with other unsaturated monomers. These polymers generally have a density between about 0.850 grams per cubic centimeter and about 0.970 grams per cubic centimeter. Preferably, the density is between about 0.85 grams per cubic centimeter and about 0.955 grams per cubic centimeter, more preferably, between about 0.850 grams per cubic centimeter and 0.920 grams per cubic centimeter.

Ethylene/styrene interpolymers useful in the present invention include substantially random interpolymers prepared by polymerizing an olefin monomer (i.e., ethylene, propylene, or alpha-olefin monomer) with a vinylidene aromatic monomer, hindered aliphatic vinylidene monomer, or cycloaliphatic vinylidene monomer. Suitable olefin monomers contain from 2 to 20, preferably from 2 to 12, more preferably from 2 to 8 carbon atoms. Preferred such monomers include ethylene, propylene, 1-butene, 4-methyl-1-pentene, 1-hexene, and 1-octene. Most preferred are ethylene and a combination of ethylene with propylene or C₄₋₈ alpha-olefins. Optionally, the ethylene/styrene interpolymers polymerization components can also include ethylenically unsaturated monomers such as strained ring olefins. Examples of strained ring olefins include norbornene and C₁₋₁₀ alkyl- or C₆₋₁₀ aryl-substituted norbornenes.

Ethylene/unsaturated ester copolymers useful in the present invention can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of about 5 to about 50 percent by weight based on the weight of the copolymer, and is preferably in the range of about 15 to about 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. The melt index of the ethylene/unsaturated ester copolymers can be in the range of about 0.5 to about 50 grams per 10 minutes.

Halogenated ethylene polymers useful in the present invention include fluorinated, chlorinated, and brominated olefin polymers. The base olefin polymer can be a homopolymer or an interpolymer of olefins having from 2 to 18 carbon atoms. Preferably, the olefin polymer will be an interpolymer of ethylene with propylene or an alpha-olefin monomer having 4 to 8 carbon atoms. Preferred alpha-olefin comonomers include 1-butene, 4-methyl-1-pentene, 1-hexene, and 1-octene. Preferably, the halogenated olefin polymer is a chlorinated polyethylene.

Natural rubbers suitable in the present invention include high molecular weight polymers of isoprene. Preferably, the natural rubber will have a number average degree of polymerization of about 5000 and a broad molecular weight distribution.

Preferably, the nitrile rubber of the present invention is a random copolymer of butadiene and acrylonitrile.

The polybutadiene rubber useful in the present invention is preferably a homopolymer of 1,4-butadiene.

Useful styrene/butadiene rubbers include random copolymers of styrene and butadiene. Typically, these rubbers are produced by free radical polymerization. Styrene/butadiene/styrene block copolymers of the present invention are a phase-separated system. The styrene/ethylene/butadiene/styrene copolymers are also useful in the present invention.

Useful free-radical inducing species include organic peroxides, Azo free radical initiators, and bicumene. Preferably, the free-radical inducing species is an organic peroxide. Also, oxygen-rich environments are preferred for initiating useful free-radicals. Preferable organic peroxides include dicumyl peroxide, Vulcup R, and dialkyl peroxides. More preferable, the organic peroxide is a dialkyl peroxide selected from the group consisting of 2,5-bis(tert-butylperoxy)-2,5-dimethylhexane and 2,5-bis(tert-butylperoxy)-2,5-dimethyl-3-hexyne. Most preferably, the organic peroxide is 2,5-bis(tert-butylperoxy)-2,5-dimethyl-3-hexyne.

The organic peroxide can be added via direct injection. Preferably, the free-radical inducing species is present in an amount between about 0.005 weight percent and about 20.0 weight percent, more preferably, between about 0.01 weight percent and about 10.0 weight percent, most preferably, between about 0.03 weight percent and about 5.0 weight percent.

In addition to or as alternative to the free-radical inducing species, the polymer can form free radicals when subjected to shear energy, heat, or radiation. Accordingly, shear energy, heat, or radiation can act as free-radical inducing species. Moreover, the free-radical trapping species can act in the presence of free-radicals generated by shear energy, heat, or radiation as the free-radical trapping species would act in the presence of free radicals generated by the previously-described free-radical inducing species.

It is believed that when the free-radicals are generated by an organic peroxide, oxygen, air, shear energy, heat, or radiation, the combination of the free-radical trapping species and the source of free-radical is required for coupling of the polymer. Control of this combination determines the molecular architecture of the coupled polymer (that is, the rheology-modified polymer). Sequential addition of the free-radical trapping species followed by gradual initiation of free radicals provides an unprecedented degree of control over the molecular architecture.

It is also believed that grafting sites can be initiated on the polymer and capped with the free-radical trapping species to form a pendant stable free radical. Later, the pendant stable free radical can couple with a subsequently formed free radical, imparting desired levels of homogeneity to the resulting rheology-modified polymer.

In yet another embodiment, the present invention is a rheology-modifiable polymeric composition, which comprises (1) a polymer selected from the group consisting of free-radical degradable polymers and free-radical carbon-carbon crosslinkable polymers and (2) a pendant stable free radical.

The pendant stable free radical is derived from grafting a free radical trapping species onto the polymer. Prior to forming the pendant stable free radical, the free radical trapping species had at least two trapping sites. After its formation, the pendant stable free radical has at least one trapping site.

The polymer is capable of forming free radicals when induced by a free-radical inducing species. In the absence of the pendant stable free radical and when induced by a free-radical inducing species, the polymer is capable of forming free radicals and preferentially undergoes an undesirable reaction. The undesirable reaction is a degradation reaction or a carbon-carbon crosslinking reaction.

In the rheology-modifiable polymeric composition, the undesirable reaction is substantially suppressed.

At the trapping sites, the free-radical trapping species is graftable onto the polymer after the polymer forms a free radical. A melt-processable, rheology-modified polymer is yielded. The rheology-modified polymer comprises the polymer coupled to the pendant stable free radical. Preferably, the rheology-modified polymer is branched. Also, preferably, the rheology-modified polymer will be substantially homogeneously coupled.

The free-radical trapping species and the free-radical inducing species can be combined with the polymer in a variety of ways, including direct compounding, direct soaking, and direct injection.

In an alternate embodiment, the present invention is a process for preparing a rheology-modifiable polymer. The first step of the process is preparing a polymer-matrix mixture by mixing its components. The components include a free-radical degradable polymer, a free-radical inducing species, and a free radical trapping species having at least two trapping sites. The free radical trapping species substantially suppresses the degradation reaction. In the second step, the polymer is grafted through the free-radical trapping species.

In this embodiment, it is possible to control the molecular architecture of the resulting rheology-modified polymer. To do so, the rate of adding the free-radical inducing species in the first step should (1) be controlled and (2) follows the addition or occur simultaneously with the addition of the free-radical trapping species. Preferably, the free-radical inducing species will be added following addition of the free-radical trapping species (that is, in a second step and the grafting will occur in a third step).

It is possible to substitute a pendant stable free radical for the free-radical trapping species. To that end, the free-radical trapping species can be separately grafted onto the polymer to form a pendant stable free radical in an inert atmosphere. The polymer matrix will then include the polymer, the pendant stable free radical, and a free-radical inducing species.

In an alternate embodiment, the present invention is a process for preparing a rheology-modifiable polymer. The first step of the process is preparing a polymer-matrix mixture by mixing its components. The components include a free-radical carbon-carbon crosslinkable polymer, a free-radical inducing species, and a free radical trapping species having at least two trapping sites. The free radical trapping species substantially suppresses the carbon-carbon crosslinking reaction. In the second step, the polymer is grafted through the free-radical trapping species.

In this embodiment, it is possible to control the molecular architecture of the resulting rheology-modified polymer. To do so, the rate of adding the free-radical inducing species in the first step should (1) be controlled and (2) follows the addition or occur simultaneously with the addition of the free-radical trapping species. Preferably, the free-radical inducing species will be added following addition of the free-radical trapping species (that is, in a second step and the grafting will occur in a third step).

It is possible to substitute a pendant stable free radical for the free-radical trapping species. To that end, the free-radical trapping species can be separately grafted onto the polymer to form a pendant stable free radical in an inert atmosphere. The polymer matrix will then include the polymer, the pendant stable free radical, and a free-radical inducing species.

In a preferred embodiment, the present invention is an article of manufacture prepared from the rheology-modifiable polymer composition. Any number of processes can be used to prepare the articles of manufacture. Specifically useful processes include injection molding, extrusion, compression molding, rotational molding, thermoforming, blowmolding, powder coating, Banbury batch mixers, fiber spinning, and calendaring.

Suitable articles of manufacture include wire-and-cable insulations, wire-and-cable semiconductive articles, wire-and-cable coatings and jackets, cable accessories, shoe soles, multicomponent shoe soles (including polymers of different densities and type), weather stripping, gaskets, profiles, durable goods, rigid ultradrawn tape, run flat tire inserts, construction panels, composites (e.g., wood composites), pipes, foams, blown films, and fibers (including binder fibers and elastic fibers).

Foam products include, for example, extruded thermoplastic polymer foam, extruded polymer strand foam, expandable thermoplastic foam beads, expanded thermoplastic foam beads, expanded and fused thermoplastic foam beads, and various types of crosslinked foams. The foam products may take any known physical configuration, such as sheet, round, strand geometry, rod, solid plank, laminated plank, coalesced strand plank, profiles, and bun stock.

Foams made from a rheology-modified propylene copolymer of the present invention are particularly useful. An example is a foam comprising a rheology-modified propylene copolymer comprising at least 50 weight percent of units derived from propylene, based on the total propylene copolymer, and units derived from ethylenically unsaturated comonomers and having a melt flow rate in the range of from 0.5 to 8 g/10 min and a melt strength of at least 5 centiNewtons. The exemplified foam can further have a density of 800 kg/m³ or less.

### EXAMPLES

The following non-limiting examples illustrate the invention.

### Comparative Examples 1-2 and Example 3

Two comparative examples and one example of the present invention were prepared with a polypropylene elastomer, having an ethylene content of 15 weight percent, a melt flow rate of 2 grams per 10 minutes, and a density of 0.858 grams per cubic centimeter. The melt flow rate was measured at 230 degrees Celsius according to ASTM D-1238.

Each of the formulations shown in Table I, excluding the peroxide, was prepared in a Brabender mixer to make 40 grams samples at 110 degrees Celsius for 3 minutes. The peroxide was subsequently added. The composition was compounded for 4 additional minutes.

The PROSTAB™ 5415 bis(1-oxyl-2,2,6,6-tetramethylpiperidine-4-yl)sebacate (the “bis-TEMPO”) was commercially available from the Ciba Specialty Corporation. The Dicup R™ organic peroxide was commercially available from Geo Specialty Chemicals while the Luperox™ 130 2,5-Bis(tert-butylperoxy)-2,5-dimethyl-3-hexyne organic peroxide was commercially available from Atofina.

The reaction kinetics were investigated using a moving die rheometer (MDR) at 182 degrees Celsius. The results are reported in Table I.

For each evaluated composition, the MDR generated torque versus time data. In addition to the set temperature of 182 degrees Celsius, the MDR was set for a frequency of 100 cycles per minute and an arc of 0.5 degrees. The test specimens weighed about 5 grams and were placed between Mylar™ sheets and then into the MDR for evaluation. The set temperature and evaluation time were set depending on the end-use application and the composition.

TABLE I

| Component | C. Ex. 1 | C. Ex. 2 | Ex. 3 |
|---|---|---|---|
| polypropylene | 98.0 | 98.0 | 96.75 |
| bis-TEMPO | | | 3.0 |
| Dicup R | 2.0 | | |
| Luperox ™ 130 | | 2.0 | 0.25 |

MDR: 182 degrees Celsius

| | | | |
|---|---|---|---|
| Time (minutes) | 12 | 12 | 120 |
| Minimum Torque, ML (lb-in) | 0.01 | 0.02 | 0.29 |
| Maximum Torque, MH (lb-in) | 0.03 | 0.03 | 0.35 |
| Final Torque, MF (lb-in) | 0.02 | 0.03 | 0.33 |
| Onset of torque increase (min) | N/A | N/A | 4.00 |

The composition containing the free-radical trapping species yielded higher torque values when compared with the compositions without the free-radical trapping species. The rheology-modifiable polymeric composition yielded a rheology-modified polymer having an increase in torque (a measure of viscosity) without undesirable degrees of chain scission or carbon-FRTS-carbon crosslinking.

### Comparative Examples 4-5 and Examples 6-8

Two comparative examples and three examples were prepared with an experimental grade propylene-ethylene copolymer having an ethylene content of 12 weight percent, a melt flow rate of 8 grams per 10 minutes, and a density of 0.866 grams per cubic centimeter. The formulations are shown in Table II.

The PROSTAB™ 5415 bis-TEMPO was commercially available from the Ciba Specialty Corporation. The Dicup R™ organic peroxide was commercially available from Hercules, Inc.

First, the polymer material was added to Brabender mixer to make 40 grams samples, melted, and mixed for homogeneity (as indicated by the torque trace). Next, the peroxide and the free-radical trapping species were added to the melted polymer. The mixing continued until completion of the desired cycle as shown in Table II. Also, Table II indicates whether the mixing steps were concluded under an inert gas blanket.

The various compositions were retrieved from the mixer and then pressed into sheets. After solidification, the compositions were cut into granular form for measuring melt flow rate (230 degrees Celsius, 2.16 kg).

TABLE II

| Component (ppm) | C. Ex. 4 | C. Ex. 5 | Ex. 6 | Ex. 7 | Ex. 8 |
|---|---|---|---|---|---|
| Dicup R | | | | | 250 |
| bis-TEMPO | | | 4500 | 3000 | 4500 |
| Argon Blanket | Yes | No | No | Yes | Forced |
| | | | | | Air |
| Settings, Batch Cycle | 7 min., | 7 min., | 7 min., | 7 min., | 7 min., |
| Time | 140° C.; | 140° C.; | 140° C.; | 140° C.; | 140° C.; |
| | 9 min., | 13 min., | 7 min., | 7 min., | 7 min., |
| | 250° C. | 250° C. | 165° C. | 165° C. | 165° C. |
| Final Melt Temp. (° C.) | 230 | 230 | 161 | 158 | 150 |
| Melt Flow Rate | 11.6 | 13.0 | 8.86 | 8.75 | 8.48 |

### Comparative Examples 9-10 and Example 11

Two comparative examples and an example of the present invention were prepared with a powder impact propylene copolymer, having a melt flow rate of 2.3 grams per 10 minutes, and a density of 0.900 grams per cubic centimeter. The melt flow rate was measured at 230 degrees Celsius according to ASTM D-1238.

When formulated with a stabilizing package of 1000 ppm Irganox 1330 1,3,5-trimethyl-2,4,6-tris(3,5-di-t-butyl-4-hydroxybenzyl) benzene antioxidant and 70 ppm calcium stearate, the impact propylene copolymer formulation had a melt flow rate of 1.6 grams per 10 minutes.

For the processed samples taken from the mixer, no stabilizing additives were added during melt flow rate measurements. The formulations are shown in Table III.

First, the polymer material was added to Brabender mixer to make 40 grams samples, melted, and mixed for homogeneity (as indicated by the torque trace). Next, the peroxide and the free-radical trapping species were added to the melted polymer. The mixing continued until completion of the desired cycle as shown in Table III. Also, Table III indicates whether the mixing steps were concluded under inert gas blanketing.

The various compositions were retrieved from the mixer and then pressed into sheets. After solidification, the compositions were cut into granular form for measurements of melt flow rate (230 degrees Celsius, 2.16 kg).

The polypropylene was commercially available from The Dow Chemical Company as C104-01 impact propylene copolymer. The PROSTAB™ 5415 bis-TEMPO was commercially available from the Ciba Specialty Corporation. The Dicup R™ organic peroxide was commercially available from Hercules, Inc.

TABLE III

| Component (ppm) | C. Ex. 9 | C. Ex. 10 | Ex. 11 |
|---|---|---|---|
| Dicup R | | | 250 |
| bis-TEMPO | | | 1500 |
| Argon Blanket | Yes | No | Yes |
| Settings, Batch Cycle Time | 7 min., 180° C.; | 7 min., 180° C.; | 7 min., 180° C.; |
| | 9 min., 250° C. | 6 min., 250° C. | 1.5 min., 190° C. |
| Final Melt Temp. (° C.) | 230 | 230 | 178 |
| Melt Flow Rate | 5.4 | 40 | 1.96 |

### Comparative Examples 12 and 13 and Examples 14-16

Two comparative examples and three examples of the present invention were prepared with a powder impact propylene copolymer, having a melt flow rate of 1.05 grams per 10 minutes and a density of 0.900 grams per cubic centimeter, 1000 ppm Irganox 1330 1,3,5-trimethyl-2,4,6-tris(3,5-di-t-butyl-4-hydroxybenzyl) benzene antioxidant, and 70 ppm calcium stearate. The melt flow rate was measured at 230 degrees Celsius according to ASTM D-1238.

For Comparative Example 13, 4,4′-oxybis(benzenesulfonyl azide) CAS# [7456-68-0] (“BSA”) was pre-blended with the base polymer resin. For Examples 14-16, the polymer was pre-blended with Luperox™ 130 organic peroxide and PROSTAB™ 5415 bis-TEMPO and then allowed to soak for about one hour to absorb the peroxide.

All exemplified formulations were prepared into evaluated materials via a continuous mixing process on a twin-screw extruder (ZSK-30 available from Coperion Corporation). Under a nitrogen blanket, the extruder used a production rate of 20 lbs/hr and a speed of 200 rpm with its extrusion melt discharge temperature within the range of 190-200 degrees Celsius. After extrusion, the material was pelletized.

The materials were analyzed for melt flow rate, melt strength, gel measurements, dynamic oscillatory shear viscosity, and chain branching. The gel measurements were determined by extruding the materials through a film die and using a Film Scanning System (FS-3) from Optical Counter System (OCS). The dynamic oscillatory shear viscosity was determined using a Weissenberg Rheogoniometer fitted with parallel plate geometry and measured at 200 degrees Celsius and 2 percent strain.

The intrinsic viscosity and the molecular weight (i.e., chain branching) were determined using gel permeation chromatography (“GPC”) analysis. For the GPC analysis, a Laboratories PL-GPC-220 high temperature chromatographic unit equipped with three linear mixed bed columns, 300×7.5 mm (Polymer Laboratories PLgel Mixed B (10-micron particle size)) is used. The oven temperature is at 160 degrees Celsius with the autosampler hot zone at 160 degrees Celsius and the warm zone at 145 degrees Celsius. The solvent is 1,2,4-trichlorobenzene containing 200 ppm 2,6-di-t-butyl-4-methylphenol. The flow rate is 1.0 milliliter/minute and the injection size is 100 microliters. A 0.15% by weight solution of the sample is prepared for injection by dissolving the sample in nitrogen purged 1,2,4-trichlorobenzene containing 200 ppm 2,6-di-t-butyl-4-methylphenol for 2.5 hrs at 160 degrees Celsius with gentle mixing.

The additive amounts, melt flow rate, melt strength, and gel measurements are reported in Table IV. The oscillatory shear viscosity measurements are shown in Table V.

TABLE IV

| Component (ppm) | C. Ex. 12 | C. Ex. 13 | Ex. 14 | Ex. 15 | Ex. 16 |
|---|---|---|---|---|---|
| BSA | | 250 | | | |
| Luperox ™ 130 | | | 250 | 250 | 500 |
| bis-TEMPO | | | 1500 | 750 | 4500 |
| Melt Flow Rate | 1.05 | 0.6 | 0.7 | 1.1 | 1.1 |
| Melt Strength (cN) | 6.0 | 11.3 | 10.4 | 5.7 | 6.7 |

Gel Number (avg./m²)

| | | | | |
|---|---|---|---|---|
| 50 μm | 9883 | 40231 | 7342 | 4420 |
| 100 μm | 725 | 1658 | 798 | 511 |
| 200 μm | 259 | 672 | 267 | 119 |
| 300 μm | 51 | 141 | 51 | 22 |
| 400 μm | 7 | 60 | 13 | 2 |
| 500 μm | 0 | 13.3 | 7 | 0 |
| 600 μm | 0 | 7 | 0 | 2 |
| 800 μm | 0 | 4 | 0 | 0 |
| 1600 μm | 0 | 0 | 0 | 0 |
| GN-300 | 58 | 225.3 | 71 | 46 |
| GN-600 | 0 | 11 | 0 | 2 |

TABLE V

| | C. Ex. 12 | C. Ex. 13 | Ex. 14 |
|---|---|---|---|
| Frequency (rad/sec) | Viscosity (Pascal-Seconds) | | |
| 0.1 | 16243.99 | 21221.52 | 19166.76 |
| 0.1778 | 14673.68 | 18052.18 | 16109.58 |
| 0.3162 | 13109.68 | 15300.84 | 13772.84 |
| 0.5623 | 11469.51 | 12837.63 | 11586.53 |
| 1 | 9796.205 | 10593.88 | 9571.815 |
| 1.778 | 8136.4 | 8561.843 | 7759.019 |
| 3.162 | 6571.174 | 6770.377 | 6157.943 |
| 5.623 | 5153.863 | 5228.201 | 4767.712 |
| 10 | 3940.707 | 3948.457 | 3598.65 |
| 17.78 | 2933.816 | 2910.869 | 2662.452 |
| 31.62 | 2128.028 | 2095.774 | 1908.51 |
| 56.23 | 1505.659 | 1477.968 | 1353.689 |
| 100 | 1048.994 | 1030.788 | 937.1943 |

Comparative Example 12 had a low/high shear viscosity ratio of about 15.5. Comparative Example 13 had a low/high shear viscosity ratio of about 20.6. Example 14 had a low/high shear viscosity ratio of about 20.4.

### Comparative Example 17 and Examples 18 and 19

One comparative example and two examples were prepared with an experimental grade propylene-ethylene copolymer having 12 weight percent ethylene comonomer content, a melt flow rate of 2.0 grams per 10 minutes, and a density of 0.867 grams per cubic centimeter. The melt flow rate was measured at 230 degrees Celsius according to ASTM D-1238.

For Examples 18 and 19, the polymer was pre-blended with Luperox™ 130 organic peroxide and PROSTAB™ 5415 bis-TEMPO and then allowed to soak for about one hour to absorb the peroxide.

All exemplified formulations were prepared into evaluated materials via a continuous mixing process on a twin-screw extruder (ZSK-30 available from Coperion Corporation). Under a nitrogen blanket, the extruder used a production rate of 10-15 lbs/hr and a speed of 200 rpm with its extrusion melt discharge temperature within the range of 210 to 217 degrees Celsius. After extrusion, the material was pelletized.

The materials were analyzed for melt flow rate and dynamic oscillatory shear viscosity. The dynamic oscillatory shear viscosity was determined using a Weissenberg Rheogoniometer fitted with parallel plate geometry and measured at 200 degrees Celsius and 2 percent strain. The additive amounts, melt flow rate, and oscillatory shear viscosity measurements are shown in Table VI.

TABLE VI

| Component (ppm) | C. Ex. 17 | Ex. 18 | Ex. 19 |
|---|---|---|---|
| Luperox ™ 130 | | 2500 | 7500 |
| bis-TEMPO | | 20000 | 30000 |
| Rate (lbs/hr) | 15 | 15 | 10 |
| Die Pressure (psi) | 1100 | 1350 | 1325 |
| Melt Flow @ 230 degrees Celsius | 2.2 | 2.65 | 2.2 |
| Frequency (rad/sec) | Viscosity (Pascal-Seconds) | | |
| 0.1 | 6197.188 | 22437.36 | 31530.75 |
| 0.1778 | 5967.22 | 16881.02 | 21433.49 |
| 0.3162 | 5767.581 | 13119.57 | 15027.27 |
| 0.5623 | 5483.335 | 10198.55 | 10735.39 |
| 1 | 5152.997 | 7991.439 | 7777.792 |
| 1.778 | 4706.616 | 6267.48 | 5636.447 |
| 3.162 | 4170.46 | 4900.239 | 4098.662 |
| 5.623 | 3582.054 | 3809.062 | 2988.543 |
| 10 | 2965.544 | 2931.098 | 2184.063 |
| 17.78 | 2368.181 | 2222.088 | 1596.358 |
| 31.62 | 1827.462 | 1652.814 | 1160.292 |
| 56.23 | 1362.833 | 1206.257 | 838.5772 |
| 100 | 990.43 | 867.0587 | 603.1974 |

Comparative Example 17 had a low/high shear viscosity ratio of about 6.26. Example 18 had a low/high shear viscosity ratio of about 25.9. Example 19 had a low/high shear viscosity ratio of about 52.3

1. A rheology-modifiable polymeric composition comprising:
(a) a free-radical degradable polymer,
(b) a free-radical inducing species, and
(c) a free radical trapping species having at least two trapping sites, wherein
(A1) the free radical trapping species (i) substantially suppresses degradation of the polymer in the presence of the free-radical inducing species and (ii) at a trapping site, being graftable onto the polymer after the polymer forms a free radical, and
(A2) the rheology-modifiable polymeric composition yields a rheology-modified polymer being melt processable.

2. The rheology-modifiable polymeric composition of claim 1 wherein the degradation occurs by chain scission.

3. The rheology-modifiable polymeric composition of claim 1 wherein the polymer being halogenated and the degradation occurs by dehydrohalogenation.

4. The rheology-modifiable polymeric composition of claim 1 wherein the resulting rheology-modified polymer being branched.

5. The rheology-modifiable polymeric composition of claim 4 wherein the branching of the rheology-modified polymer being demonstrable by a Mark-Houwink plot.

6. The rheology-modifiable polymeric composition of claim 1 wherein the resulting rheology-modified polymer having a gel content as measured by xylene extraction (ASTM 2765) of less than about 10 weight percent.

7. The rheology-modifiable polymeric composition of claim 1 wherein the resulting rheology-modified polymer having a gel content as measured by xylene extraction (ASTM 2765) of less than about an absolute 5 weight percent greater than the gel content of the base polymer.

8. The rheology-modifiable polymeric composition of claim 1 wherein the polymer is selected from the group consisting of butyl rubber, polyacrylate rubber, polyisobutene, propylene homopolymers, propylene copolymers, styrene/butadiene/styrene block copolymers, styrene/ethylene/butadiene/styrene copolymers, polymers of vinyl aromatic monomers, vinyl chloride polymers, and blends thereof.

9. The rheology-modifiable polymeric composition of claim 1 wherein the free-radical inducing species being an organic peroxide, Azo free radical initiator, bicumene, oxygen, and air.

10. The rheology-modifiable polymeric composition of claim 1 wherein the free radical trapping species being a hindered amine-derived free radical trapping species.

11. The rheology-modifiable polymeric composition of claim 10 wherein the hindered amine-derived free radical trapping species being selected from the group consisting of multi-functional molecules having at least two functional groups of 2,2,6,6,-tetramethyl piperidinyl oxy and derivatives thereof.

12. The rheology-modifiable polymeric composition of claim 11 wherein the hindered amine-derived free radical trapping species having at least two nitroxyl groups derived from oxo-TEMPO, hydroxy-TEMPO, esters of hydroxy-TEMPO, polymer-bound TEMPO, PROXYL, DOXYL, di-tertiary butyl N oxyl, dimethyl diphenylpyrrolidine-1-oxyl, 4 phosphonoxy TEMPO, or metal complexes with TEMPO.

13. (canceled)

14. A rheology-modifiable polymeric composition comprising:
(a) a free-radical degradable polymer and
(b) a free-radical inducing species, and
(c) a free radical trapping species graftable via a free-radical-initiated carbon-FRTS-carbon coupling bond to the polymer,
wherein the resulting rheology-modified polymer having a
Maximum Torque<1.30*Minimum Torque
measured by a moving die rheometer at the polymer's coupling temperature, a frequency of 100 cycles per minute, and an arc of 0.5 degrees.

15. A rheology-modifiable polymeric composition comprising:
(a) a free-radical carbon-carbon crosslinkable polymer,
(b) a free-radical inducing species, and
(c) a free radical trapping species having at least two trapping sites, wherein
(A1) the free radical trapping species (i) substantially suppresses carbon-carbon crosslinking of the polymer in the presence of the free-radical inducing species and (ii) at a trapping site, being graftable onto the first polymer after the first polymer forms a free radical, and
(A2) the rheology-modifiable polymeric composition yields a rheology-modified polymer being melt processable.

16. The rheology-modifiable polymeric composition of claim 15 wherein the resulting rheology-modified polymer being branched.

17. The rheology-modifiable polymeric composition of claim 16 wherein the branching of the rheology-modified polymer being demonstrable by a Mark-Houwink plot.

18. The rheology-modifiable polymeric composition of claim 15 wherein the resulting rheology-modified polymer having a gel content as measured by xylene extraction (ASTM 2765) of less than about 10 weight percent.

19. The rheology-modifiable polymeric composition of claim 15 wherein the resulting rheology-modified polymer having a gel content as measured by xylene extraction (ASTM 2765) of less than about an absolute 5 weight percent greater than the gel content of the base polymer.

20. The rheology-modifiable polymeric composition of claim 15 wherein the polymer is selected from the group consisting of acrylonitrile butadiene styrene rubber, chloroprene rubber, chlorosulfonated polyethylene rubber, ethylene/alpha-olefin copolymers, ethylene/diene copolymer, ethylene homopolymers, ethylene/propylene/diene monomers, ethylene/propylene rubbers, ethylene/styrene interpolymers, ethylene/unsaturated ester copolymers, fluoropolymers, halogenated polyethylenes, hydrogenated nitrile butadiene rubber, natural rubber, nitrile rubber, polybutadiene rubber, silicone rubber, styrene/butadiene rubber, styrene/butadiene/styrene block copolymers, styrene/ethylene/butadiene/styrene copolymers, and blends thereof.

21. (canceled)

22. A rheology-modifiable polymeric composition comprising:
(a) a free-radical carbon-carbon crosslinkable polymer and
(b) a free-radical inducing species, and
(c) a free radical trapping species graftable via a free-radical-initiated carbon-FRTS-carbon coupling bond to the polymer,
wherein the resulting rheology-modified polymer having a
Maximum Torque<1.30*Minimum Torque
measured by a moving die rheometer at the polymer's coupling temperature, a frequency of 100 cycles per minute, and an arc of 0.5 degrees.

23-35. (canceled)
